(19) United States
(12) Patent Application Publication
(10) Pub. No.: US 2026/0239303 A1
(43) Pub. Date: Aug. 13, 2026

(54) MAPPING OF SUB-CHANNELS AND PHYSICAL RESOURCE BLOCKS

(71) Applicant: Nokia Technologies Oy, Espoo (FI)

(72) Inventors: Naizheng ZHENG, Beijing (CN); Timo Erkki LUNTTILA, Espoo (FI); Yong LIU, Shanghai (CN); Jianguo LIU, Shanghai (CN); Laura Luque SANCHEZ, Aalborg (DK); Renato Barbosa ABREU, Aalborg (DK); Torsten WILDSCHEK, Gloucester (GB)

(21) Appl. No.: 19/155,895

(22) PCT Filed: Feb. 17, 2023
(86) PCT No.: PCT/CN2023/076833

§ 371 Date: Aug. 12, 2025

(51) Int. Cl. H04W 72/04

(52) U.S. Cl. CPC H04W 72/04

(57) ABSTRACT

Example embodiments of the present disclosure relate to a terminal device, a network device, methods, apparatuses and a computer readable storage medium for a mapping of sub-channels and PRBs. A terminal device may determine a number of remaining PRBs after a mapping between multiple sub-channels and a resource pool or a physical resource set, or applying a guard band; and the terminal device may further adjust the mapping based on the number of remaining PRBs. In one illustrated example, one of the multiple sub-channels may be extended by the number of remaining PRBs. In another illustrated example, a further sub-channel may be mapped with the remaining PRBs. As such, the remaining PRBs may be used for sidelink transmission and the spectrum efficiency may be improved.

### FIELD

Example embodiments of the present disclosure generally relate to the field of telecommunication and in particular, to a terminal device, a network device, methods, apparatuses and a computer readable storage medium for a mapping of sub-channels and physical resource blocks (PRBs).

### BACKGROUND

Sidelink (SL) technology has been widely used in various scenarios. The communication data in some scenarios are only interacted within a certain area, and a type of wireless communication protocol—sidelink-unlisenced (SL-U) is suitable for this kind of wireless short-distance communication application scenarios.

For an SL operation, a mapping between sub-channels and PRBs may be considered. For example, user equipment (UE) may determine a set of resource blocks (RBs) assigned to a sidelink resource pool (RP) and further determine the sub-channels. However, the resource blocks may not be fully used and a loss of spectrum efficiency may occur. Therefore, a further study of the mapping is needed.

### SUMMARY

In general, example embodiments of the present disclosure provide a solution for a mapping of sub-channels and PRBs.

In a first aspect, there is provided a terminal device. The terminal device comprises at least one processor and at least one memory storing instructions that, when executed by the at least one processor, cause the terminal device at least to: determine a number of remaining PRBs after a mapping between a plurality of sub-channels and a resource pool or a physical resource set, or applying a guard band; and adjust the mapping based on the number of remaining PRBs.

In a second aspect, there is provided a network device. The network device comprises at least one processor and at least one memory storing instructions that, when executed by the at least one processor, cause the network device at least to: transmit, to a terminal device, at least one of: a first indication indicating to leave remaining PRBs unused, a second indication indicating to extend a sub-channel of a plurality of sub-channels nearest to the remaining PRBs by a number of the remaining PRBs, a third indication indicating to map a sub-channel with the remaining PRBs, or a fourth indication indicating the terminal device to adjust the mapping according to the terminal device's implementation, the number of the remaining PRBs being determined by the terminal device after a mapping between the plurality of sub-channels and a resource pool or a physical resource set, or applying a guard band.

In a third aspect, there is provided a method performed by a terminal device. The method comprises: determining, at a terminal device, a number of remaining PRBs after a mapping between a plurality of sub-channels and a resource pool or a physical resource set, or applying a guard band; and adjusting the mapping based on the number of remaining PRBs.

In a fourth aspect, there is provided a method performed by a network device. The method comprises: transmitting, at a network device to a terminal device, at least one of: a first indication indicating to leave remaining PRBs unused, a second indication indicating to extend a sub-channel of a plurality of sub-channels nearest to the remaining PRBs by a number of remaining PRBs, a third indication indicating to map a sub-channel with the remaining PRBs, or a fourth indication indicating the terminal device to adjust the mapping according to the terminal device's implementation, the number of the remaining PRBs being determined by the terminal device after a mapping between the plurality of sub-channels and a resource pool or a physical resource set, or applying a guard band.

In a fifth aspect, there is provided an apparatus. The apparatus comprises: means for determining, at a terminal device, a number of remaining PRBs after a mapping between a plurality of sub-channels and a resource pool or a physical resource set, or applying a guard band; and means for adjusting the mapping based on the number of remaining PRBs.

In a sixth aspect, there is provided an apparatus. The apparatus comprises: means for transmitting, at a network device to a terminal device, at least one of: a first indication indicating to leave remaining PRBs unused, a second indication indicating to extend a sub-channel of a plurality of sub-channels nearest to the remaining PRBs by a number of the remaining PRBs, a third indication indicating to map a sub-channel with the remaining PRBs, or a fourth indication indicating the terminal device to adjust the mapping according to the terminal device's implementation, a number of remaining PRBs being determined by the terminal device after a mapping between the plurality of sub-channels and a resource pool or a physical resource set, or applying a guard band.

In a seventh aspect, there is provided a non-transitory computer readable medium comprising program instructions for causing an apparatus to perform at least the method in the third or fourth aspect.

In an eighth aspect, there is provided a computer program comprising instructions, which, when executed by an apparatus, cause the apparatus at least to perform the method in the third or fourth aspect.

In a ninth aspect, there is provided a terminal device. The terminal device comprises: determining circuitry configured to determine, at a terminal device, a number of remaining PRBs after a mapping between a plurality of sub-channels and a resource pool or a physical resource set, or applying a guard band; and adjusting circuitry configured to adjust the mapping based on the number of remaining PRBs.

In a tenth aspect, there is provided a network device. The network device comprises: transmitting circuitry configured to transmit, to a terminal device, at least one of: a first indication indicating to leave remaining PRBs unused, a second indication indicating to extend a sub-channel of a plurality of sub-channels nearest to the remaining PRBs by a number of the remaining PRBs, a third indication indicating to map a sub-channel with the number of remaining PRBs, or a fourth indication indicating the terminal device to adjust the mapping according to the terminal device's implementation, a number of the remaining PRBs being determined by the terminal device after a mapping between the plurality of sub-channels and a resource pool or a physical resource set, or applying a guard band.

In an eleventh aspect, there is provided a computer readable medium comprising program instructions that, when executed by an apparatus, cause the apparatus to perform at least the method in the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIGS. 1A-1C illustrate examples of mapping according to options 1-3 respectively;

FIGS. 2A-2C illustrate examples of mapping between sub-channels and PRBs with different numbers of PRBs of the resource pool of different sub-channel sizes;

FIG. 3 illustrates an example of a network environment in which some example embodiments of the present disclosure may be implemented;

FIG. 4 illustrates an example of a process flow in accordance with some example embodiments of the present disclosure;

FIGS. 5A-5E illustrate examples of mapping in accordance with some example embodiments of the present disclosure;

FIG. 6 illustrates an example of mapping in accordance with some example embodiments of the present disclosure;

FIG. 7 illustrates a flowchart of a method implemented at a terminal device in accordance with some example embodiments of the present disclosure;

FIG. 8 illustrates a flowchart of a method implemented at a network device in accordance with some example embodiments of the present disclosure;

FIG. 9 illustrates a simplified block diagram of a device that is suitable for implementing some example embodiments of the present disclosure; and

FIG. 10 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

A channel, such as a physical sidelink control channel (PSCCH) or a physical sidelink shared channel (PSSCH) may be used for a transmission in the sidelink technology. For contiguous resource block (RB)-based PSCCH/PSSCH transmission in SL-U, regarding mapping between sub-channel and PRBs, it is agreed to further study the following options: option 1, option 2, and option 3.

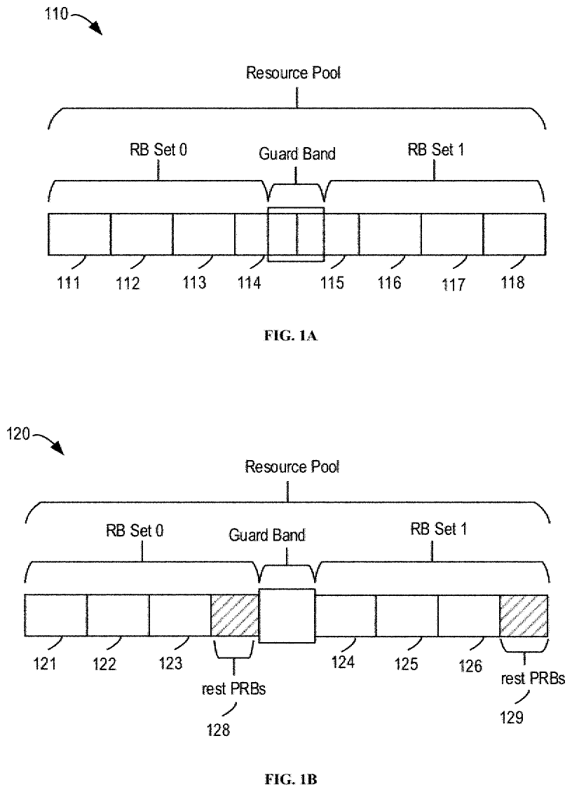

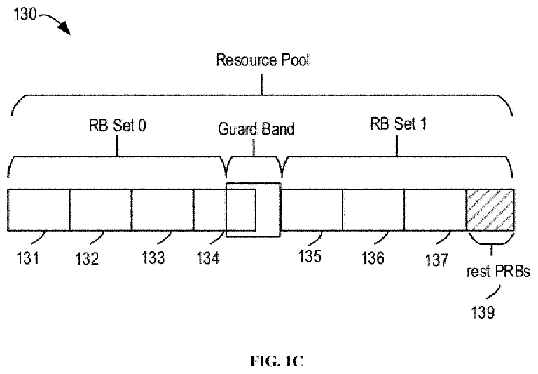

Option 1 (sub-channel aligns with resource pool boundary): Same as in legacy NR SL, i.e., the mapping of sub-channel starts from the first PRB of the resource pool and mapped sequentially within the resource pool according to the sub-channel size. FIG. 1A illustrates an example of the mapping 110 according to option 1. As shown in FIG. 1A, there are 8 sub-channels 111-118 mapped sequentially within the resource pool. However, the following issues are needed to be further studied: whether/how to use sub-channel(s) (such as sub-channels 114-115 in FIG. 1A) which include intra-cell guard band PRBs; and/or whether/how to handle the case when the number of PRBs of the resource pool cannot be divided by sub-channel size.

Option 2 (sub-channel aligns with RB set boundary): In each RB set, the mapping of sub-channel starts from the first PRB of the RB set and mapped sequentially within the RB set according to the sub-channel size. FIG. 1B illustrates an example of the mapping 120 according to option 2. As shown in FIG. 1B, there are 3 sub-channels 121-123 mapped within the RB set 0 and 3 sub-channel 124-126 mapped within the RB set 1 without overlapping guard band PRBs. However, the following issues are needed to be further studied: whether/how to use intra-cell guard band PRBs; and/or whether/how to handle the case when the number of PRBs of one RB set cannot be divided by sub-channel size. For examples, there may be rest PRBs 128 and 129 unused, as shown in FIG. 1B.

Option 3 (sub-channel aligns with RB set boundary): In each RB set, the mapping of sub-channel starts from the first PRB of the RB set and mapped sequentially within the RB set and/or guard band PRB according to the sub-channel size. FIG. 1C illustrates an example of the mapping 130 according to option 3. As shown in FIG. 1C, there are 7 sub-channels 131-137 mapped within RB set 0 and RB set 1. However, the following issues are needed to be further studied: how to use intra-cell guard band PRBs; and/or how to use the sub-channel (such as sub-channel 134) including PRBs in guard band. Additionally, there may be rest PRBs 139 unused, as shown in FIG. 1C.

For an SL operation for mapping between sub-channels and PRBs, the content in the following text box describes how the sub-channel is defined, where with contiguous RB-based operation in the SL:

The UE determines the set of resource blocks assigned to a sidelink resource pool as
follows:

| | |
|---|---|
| - | The resource block pool consists of N_{PRB} PRBs. |
| - | The sub-channel m for m = 0,1, ... , numSubchannel − 1 consists of a set of |
| | n_{subCHsize} contiguous resource blocks with the physical resource block number |
| | n_{PRB} = n_{subCHRBstart} + m · n_{subCHsize} + j for j = 0,1, ... , n_{subCHsize} − 1, where |
| | n_{subCHRBstart} and n_{subCHsize} are given by higher layer parameters |
| | sl-StartRB-Subchannel and sl-SubchannelSize, respectively. |

A UE is not expected to use the last N_{PRB} mod n_{subCHsize} PRBs in the resource pool.

As specified in 3GPP TS 38. 331, the sub-channel size (such as “sl-SubchannelSize-r16” in the following text box) in an RP can be {10, 12, 15, 20, 25, 50, 75, 100} RBs, and the starting RB (such as “sl-StartRB-Subchannel-r16” in the following text box) for sub-channels can be a value between [0, 265].

| SL-ResourcePool-r16 ::= | SEQUENCE { | |
|---|---|---|
| sl-PSCCH-Config-r16 | SetupRelease { SL-PSCCH-Config-r16 } | OPTIONAL, -- Need M |
| sl-PSSCH-Config-r16 | SetupRelease { SL-PSSCH-Config-r16 } | OPTIONAL, -- Need M |
| sl-PSFCH-Config-r16 | SetupRelease { SL-PSFCH-Config-r16 } | OPTIONAL, -- Need M |
| sl-SyncAllowed-r16 | SL-SyncAllowed-r16 | OPTIONAL, -- Need M |
| sl-SubchannelSize-r16 | ENUMERATED {n10, n12, n15, n20, n25, n50, n75, n100} | OPTIONAL, -- Need M |
| dummy | INTEGER (10..160) | OPTIONAL, -- Need M |
| sl-StartRB-Subchannel-r16 | INTEGER (0..265) | OPTIONAL, -- Need M |
| sl-NumSubchannel-r16 | INTEGER (1..27) | OPTIONAL, -- Need M |
| sl-Additional-MCS-Table-r16 | ENUMERATED {qam256, qam64LowSE, qam256-qam64LowSE } | OPTIONAL, -- Need M |
| sl-ThreshS-RSSI-CBR-r16 | INTEGER (0..45) | OPTIONAL, -- Need M |
| sl-TimeWindowSizeCBR-r16 | ENUMERATED {ms100, slot100} | OPTIONAL, -- Need M |
| sl-TimeWindowSizeCR-r16 | ENUMERATED {ms1000, slot1000} | OPTIONAL, -- Need M |

...

In some cases, the number of PRBs of the resource pool (or RB set in options 2 and 3 above) cannot be divided by sub-channel size, the last N_{PRB} mod n_{subCHsize} PRBs are not used by the UE according to the content in the above text box, which result in an inefficient resource utilization.

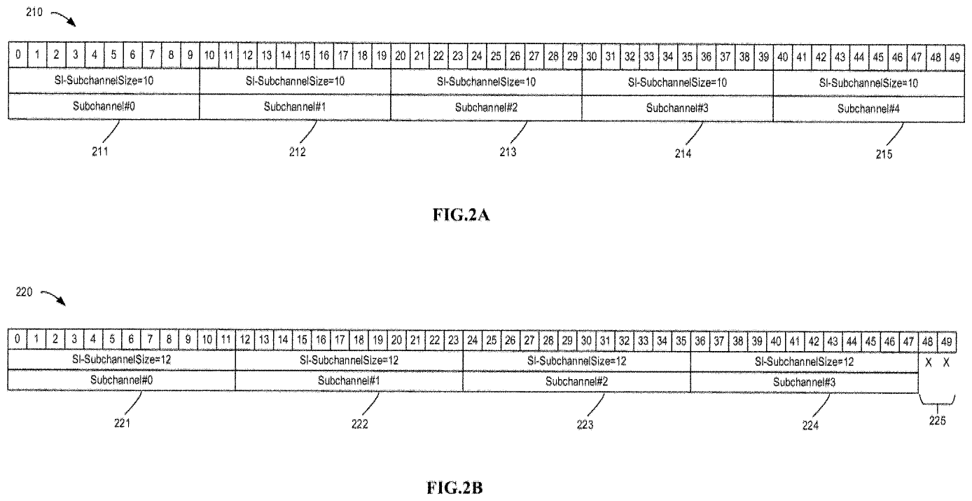

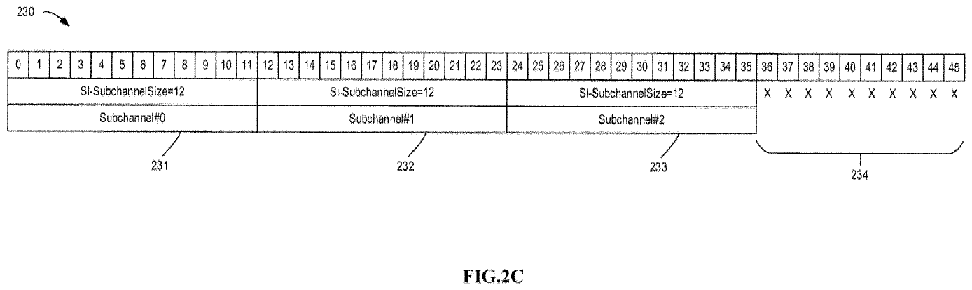

FIGS. 2A-2C illustrate examples of mapping between sub-channels and PRBs with different numbers of PRBs of the resource pool or different sub-channel sizes. FIG. 2A is an example 210 with a resource pool with NPRB=50 RBs, a sub-channel size 10, i.e., sl-SubchannelSize=10, and the starting RB is 0, i.e., sl-StartRB-Subchannel=0. As shown in FIG. 2A, the number of PRBs of the resource pool can be divided by sub-channel size, there are 5 sub-channels 211-215 and no PRBs are unused. FIG. 2B is an example 220 with a resource pool with NPRB=50 RBs, a sub-channel size 12, i.e., sl-SubchannelSize=12, and the starting RB is 0, i.e., sl-StartRB-Subchannel=0. As shown in FIG. 2B, the number of PRBs of the resource pool cannot be divided by sub-channel size, there are 4 sub-channels 221-224, and there are 2 PRBs 225 unused. FIG. 2C is an example 230 with a resource pool with NPRB=46 RBs, a sub-channel size 12, i.e., sl-SubchannelSize=12, and the starting RB is 0, i.e., sl-StartRB-Subchannel=0.

As shown in FIG. 2C, the number of PRBs of the resource pool cannot be divided by sub-channel size, there are 3 sub-channels 231-233, and there are 10 PRBs 234 unused.

Although in some cases, the number of PRBs of the resource pool may be divided by sub-channel size and no remainder PRB, in some other cases, the number of PRBs of the resource pool cannot be divided by sub-channel size and there may be remainder PRBs.

As shown in FIGS. 2B-2C, the remainder PRBs are dropped without being used, thus the resource is wasted and a loss of spectrum efficiency may occur.

Example embodiments of the present disclosure provide a solution for a mapping of sub-channels and PRBs in a resource pool or a physical resource set (such as for example, RB set). Especially, a terminal device may determine a number of remaining PRBs after a mapping between multiple sub-channels and a resource pool or a physical resource set or applying a guard band. The terminal device may further adjust the mapping based on the number of remaining PRBs. In one illustrated example embodiment, one of the multiple sub-channels may be extended by the number of remaining PRBs. In one illustrated example embodiment, a further sub-channel may be mapped with the remaining PRBs.

Through the proposed solution, the remaining PRBs may be used in a proper way and the spectrum efficiency may be improved. Principles and some example embodiments of the present disclosure will be described in detail below with reference to the accompanying drawings.

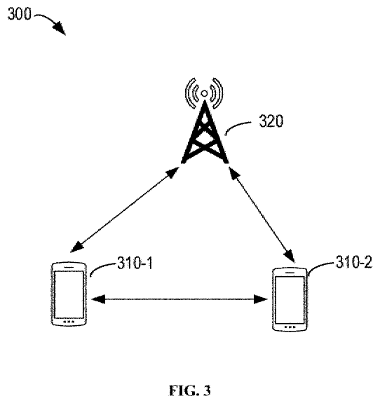

FIG. 3 illustrates an example of a network environment 300 in which some example embodiments of the present disclosure may be implemented. The network environment 300 may include a terminal device 310-1, a terminal device 310-2, and a network device 320. In some examples, the terminal device 310-1 and the terminal device 310-2 may collectively or separately be referred to as a terminal device 310.

The network device 320 may provide a wireless access cell through which the terminal device 310 may communicate with the network device 320. In some example embodiments, the network device 320 can be a gNB that provides 3GPP New Radio (NR) cell. In some other example embodiments, the network device 320 may be an eNB that provides an LTE cell. The air interfaces over which the terminal device 310 and the network device 320 communicate may be compatible with 3GPP technical specifications, such as those that define Fifth Generation (5G) NR system standards.

In the environment 300, the network device 320 can provide services to the terminal device 310, and the network device 320 and the terminal device 310 may communicate data and control information with each other. In some embodiments, the network device 320 and the terminal device 310 may communicate with direct links/channels. In the environment 300, a link from the network device 320 to the terminal device 310 is referred to as a downlink (DL), while a link from the terminal device 310 to the network device 320 is referred to as an uplink (UL).

The terminal device 310-1 and the terminal device 310-2 may also communicate directly with one another over a sidelink interface. The sidelink interface may alternatively be referred to as a ProSe interface, device-to-device (D2D) interface, or a PC5 interface or reference point. In some example embodiments, the network environment 300 may be deployed within a vehicular communication system. In a vehicular communication system, the terminal device 310-1 and the terminal device 310-2 may communicate with one another using cellular vehicle-to-everything (V2X) communications. V2X may involve vehicle-to-vehicle (V2V), vehicle-to-infrastructure (V2I), vehicle-to-network (VTN), or vehicle-to-pedestrian (V2P) communications. Thus, while FIG. 3 depicts the terminal device 310-1 and the terminal device 310-2 as mobile phones, the terminal device 310-1 and the terminal device 310-2 may be any type of user equipment.

The terminal device 310-1 and the terminal device 310-2 may communicate with one another using a sidelink resource pool. The sidelink resource pool may include a set of time/frequency resources for sidelink transmission or reception. The sidelink resource pool may be used for all unicast, groupcast, or broadcast communications for a given UE. In the frequency domain, the resource pool may include multiple sub-channels, with each sub-channel including one or more physical resource blocks (PRBs). In various example embodiments, a sub-channel may include 10, 12, 15, 20, 25, 50, 75, or 100 PRBs, for example. In some example embodiments, the PRBs of a sub-channel and the sub-channels of a resource pool may be contiguous.

In the time domain, a sidelink resource pool may include a plurality of slots, which may be contiguous or noncontiguous. In some example embodiments, the slots for a sidelink resource pool may be configured by, for example, a bitmap transmitted by the network device 320 to indicate which slots are part of a sidelink resource pool. The bitmap may have a periodicity of 10,240 ms and a bitmap length between 10-160. In some example embodiments, a physical slot may include all slots including non-sidelink slots, while a logical slot may only include slots in the resource pool. For example, consider a 10-bit bitmap as follows: [1, 1, 0, 1, 1, 0, 1, 1, 1, 1]. This bitmap indicates that 10 physical slots include 8 logical slots of a sidelink resource pool.

Resources of the sidelink may be allocated in a number of ways. For example, in a first mode (mode 1), the network device 320 may provide a sidelink grant to the terminal device 310-1 and the terminal device 310-2. In a second mode (mode 2), a transmitting UE, for example, the terminal device 310, may sense a channel and select its own resources for transmission. Mode 2 resource allocation may include a plurality of operations including, for example: resource pool configuration; sensing; resource selection; and sidelink transmission.

Resource pool configuration may include the network device 320 providing the terminal device 310-1 and the terminal device 310-2 with the configuration information via control signaling, for example, radio resource control (RRC) signaling. Additionally or alternatively, the configuration of the resource pool may include accessing predefined configuration information stored at the terminal device 310-1 and the terminal device 310-2. After a UE is configured with a resource pool, a transmitting UE may perform a sensing procedure. Within a sensing window, the transmitting UE may transmit sidelink control information (SCI) to carry a data priority indication and resource reservation information. The transmitting UE can also measure a channel quality metric, such as reference signal received power (RSRP). The sidelink RSRP measurement may be based on physical sidelink control channel (PSCCH) demodulation reference signal (DMRS) or physical sidelink shared channel (PSSCH) DMRS.

Based on the sensing operation, the transmitting UE can select resources from within a resource selection window. The resources may be selected with the subchannel granularity in the frequency domain and a slot granularity in the time domain. The transmitting UE may identify candidate resources within the resource selection window. A resource of the resource selection window may be excluded from the candidate resources if it is reserved and its associated RSRP measurement is above a predetermined threshold. The transmitting UE may then select resources from the identified candidate resources. In some example embodiments, the selection may be randomized. The transmitting UE may then encode the sidelink data on the selected resources for transmission.

Communications in the network environment 300 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G) and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 310 and the network device 320) and their connection relationships and types shown in FIG. 3 are only for the purpose of illustration without suggesting any limitation. For example, the environment 300 may include any suitable numbers of devices adapted for implementing embodiments of the present disclosure. It is noted that some example embodiments of the present disclosure can be implemented without the presence of the network device 320.

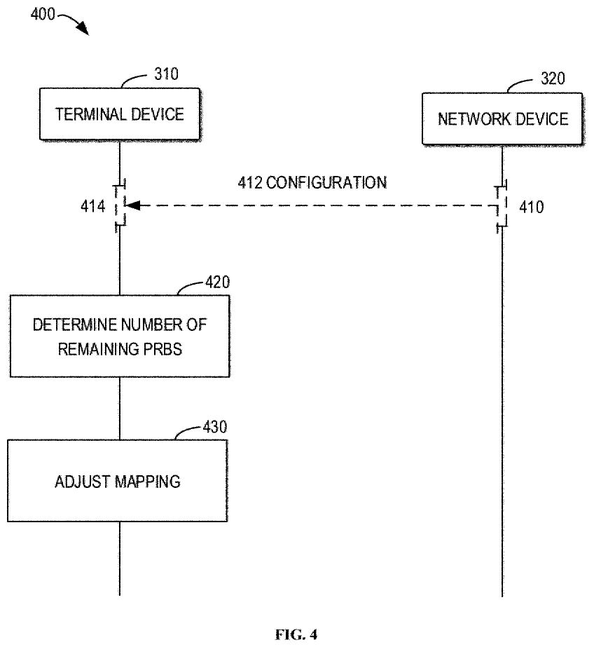

FIG. 4 illustrates an example of a process flow 400 in accordance with some example embodiments of the present disclosure. For the purpose of discussion, the process flow 400 will be described with reference to FIG. 3. The process flow 400 involves a terminal device 310 and a network device 320. It would be appreciated that although the process flow 400 has been described in the network environment 300 of FIG. 3, this process flow may be likewise applied to other communication scenarios.

Alternatively, in some example embodiments, the network device 320 may transmit 410 a configuration 412 to the terminal device 310. In some examples, the configuration 412 may include a number of PRBs in a resource pool. For example, the resource pool may be with N_{PRB} PRBs, where N_{PRB} is an integer. In some examples, the configuration 412 may include a sub-channel size. For example, the sub-channel size may be n_{subCHsize} PRBs, where n_{subCHsize} is an integer and smaller than N_{PRB}.

In some example embodiments, the configuration 412 may include an indication to indicate to the terminal device 310 how to use remaining PRBs. For example, the network device 320 may decide how to use remaining PRBs, and indicate to the terminal device 310 by the indication. In some examples, the indication may be one of: a first indication, a second indication, a third indication, or a fourth indication.

In some examples, the first indication may indicate to leave remaining PRBs unused, a second indication may indicate to extend a sub-channel of multiple sub-channels nearest to the remaining PRBs by the number of remaining PRBs, a third indication may indicate to map a sub-channel with the remaining PRBs, and a fourth indication may indicate the terminal device to adjust the mapping according to the terminal device 310's implementation.

In some examples, the indication may be implemented by 2 bits, for example, “00” refers to the first indication, “01” refers to the second indication, “10” refers to the third indication, and “11” refers to the fourth indication. It is to be understood that the indication may be implemented in other manners, such as by more than two bits, and the present disclosure does not limit this aspect.

In some example embodiments, the network device 320 may further transmit a threshold or a ratio to the terminal device 310. The terminal device 310 may receive the threshold or the ratio. The threshold or the ratio may be used by the terminal device 310 to adjust a mapping of multiple sub-channels with PRBs.

In some examples, the threshold may be a fixed value, such as N3 PRBs, where N3 is an integer less than N_{PRB}. In some examples, the threshold may be a value associated with a sub-channel size. For example, different sub-channel sizes may be configured with different thresholds. For example, the threshold is smaller than the sub-channel size. In some examples, the ratio may be a value less than 1. For example, the ratio may be 0.7, 0.8, or other values.

In some examples, the threshold or the ratio may be included in the configuration 412. In some other examples, the threshold or the ratio may be transmitted separately, for example independently, from the configuration 412.

In some examples, the threshold may be referred to as a minimum sub-channel size. In some examples, the threshold or the ratio may be carried in an RRC message or RRC signalling. For example, the threshold or the ratio may be indicated by an information element (IE) “SL-ResourcePool”, such as “dummy” RRC parameter(s).

Continuing referring to FIG. 4, the terminal device 310 may receive 414 the configuration 412. Accordingly, the terminal device 310 may obtain information in the configuration 412.

The terminal device 310 determines 420 a number of remaining PRBs after a mapping between multiple sub-channels and a resource pool or a physical resource set, or applying a guard band. In some examples, the mapping between multiple sub-channels and a resource pool or a physical resource set may be performed in a way, such as those described with reference to FIGS. 1A-1C.

In some example embodiments, the terminal device 310 may map multiple sub-channels with the PRBs based on the sub-channel size (n_{subCHsize}) and the total number of PRBs (NPRB) in a resource pool or a physical resource set. In some examples, a guard band may be further considered in the mapping, for example, the guard band is on top of the mapping.

In some examples, the remaining PRBs may also be called as remainder PRBs, rest PRBs, or the like, the present disclosure does not limit this aspect. It is to be understood that the number of remaining PRBs is smaller than the sub-channel size (n_{subCHsize}). It is to be understood that although remaining PRBs are used in the present disclosure, in some cases, there may be only one remaining PRB. In some examples, there may be multiple sets of remaining PRBs, each set includes one or more consecutive remaining PRBs, and a number of PRBs in each set is smaller than the sub-channel size (n_{subCHsize}).

In some examples, a resource pool may include more than one RB set, and the remaining PRBs may be determined per RB set. For example, one or more sets of remaining PRBs may be determined per RB set.

In some examples, the terminal device 310 may determine the remaining PRB(s), and may further determine the number of the remaining PRBs.

In some example embodiments, if there are one or more PRBs being not mapped, the remaining PRBs may include the one or more PRBs. In some example embodiments, if one of the multiple sub-channels is overlapped with a guard band, the remaining PRBs may include at least one PRB of the sub-channel overlapped with the guard band, where the at least one PRB is not located within the guard band.

The terminal device 310 adjusts 430 the mapping based on the number of remaining PRBs.

In some example embodiments, the terminal device 310 may adjust the mapping based on an indication received from the network device. In some examples, if a first indication as described above has been received, the terminal device 310 may leave the remaining PRBs unused based on the first indication. In some other examples, if a second indication as described above has been received, the terminal device 310 may extend a sub-channel (which is one of the multiple sub-channels and nearest to the remaining PRBs) by the number of remaining PRBs. In some other examples, if a third indication as described above has been received, the terminal device 310 may map the remaining PRBs as a further sub-channel. In some other examples, if a fourth indication as described above has been received, the terminal device 310 may determine how to adjust according to its own decision.

In some example embodiments, the terminal device 310 may adjust the mapping based on a comparison of the number of the remaining PRBs with a threshold. In some examples, if the number of the remaining PRBs is zero, in other words, there is no remaining PRB, the adjusting of the mapping may be omitted.

In some examples, if no indication (any of the first indication, the second indication, the third indication, or the fourth indication) is received from the network device 320 or a fourth indication is received from the network device 320, the terminal device 310 may adjust the mapping based on a comparison of the number of the remaining PRBs with a threshold.

In some examples, the threshold may be predefined at the terminal device 310. In some other examples, the threshold may be preconfigured by the network device 320, for example, the threshold may be received from the network device 320, such as in the configuration 412.

In some other examples, the terminal device 310 may determine the threshold associated with a predefined/configured/preconfigured sub-channel size (n_{subCHsize}). For example, the terminal device 310 may determine the threshold based on a ratio and the sub-channel size. For example, the terminal device 310 may determine the threshold by multiplying the sub-channel size by the ratio. In some examples, the ratio may be predefined at the terminal device 310, or may be preconfigured by the network device 320. For example, the ratio may be received from the network device, such as in the configuration 412.

In some example embodiments, the terminal device 310 may compare the number of remaining PRBs with the threshold, to determine whether the number of remaining PRBs is larger than or not smaller than the threshold.

In some example embodiments, if the number of remaining PRBs and the threshold meet a first condition, the terminal device 310 may extend a sub-channel of the multiple sub-channels by the number of remaining PRBs, or may leave the remaining PRBs unused. In some example embodiments, if the number of remaining PRBs and the threshold meet a second condition different from the first condition, the terminal device 310 may map a sub-channel with the remaining PRBs.

In one implementation, the first condition may be: the number of remaining PRBs is smaller than or not greater than the threshold; and the second condition may be: the number of remaining PRBs is not smaller than or greater than the threshold.

In some examples, if the number of remaining PRBs is not smaller than or greater than the threshold, the terminal device 310 may map a sub-channel with the remaining PRBs. As such, a further sub-channel with the remaining PRBs may be defined for further sidelink transmission.

In some examples, if the number of remaining PRBs is smaller than or not greater than the threshold, the terminal device 310 may extend a sub-channel of the plurality of sub-channels by the number of remaining PRBs. For example, a sub-channel nearest the remaining PRBs may be extended.

As such, the extended sub-channel may have more PRBs than the sub-channel size, that is, the number of PRBs in the extended sub-channel is increased, i.e., the configured sub-channel size (n_{subCHsize}) plus the number of remaining PRBs.

In some examples, if the number of remaining PRBs is smaller than or not greater than the threshold, the terminal device 310 may leave the remaining PRBs unused.

In some example embodiments, the threshold may refer to as a first threshold. In some examples, a second threshold may be further defined or preconfigured. For example, the configuration 412 described may further include the second threshold. If the number of remaining PRBs is smaller than or not greater than the threshold, the second threshold may be further considered. For example, if a sum of the configured sub-channel size and the number of remaining PRBs exceeds the second threshold, the remaining PRBs may be unused. For example, if a sum of the configured sub-channel size and the number of remaining PRBs is smaller than or equals to the second threshold, the remaining PRBs may be combined into a sub-channel of the multiple sub-channels, such as a sub-channel nearest to the remaining PRBs.

According to the embodiments described with reference to FIG. 4, the mapping between the sub-channels and the PRBs may be adjusted, and the adjusted sub-channels may be used for scheduling and resource allocation for sidelink transmission.

In addition or alternatively, the terminal device 310 may further perform a transport block size (TBS) determination. In some example embodiments, the terminal device 310 may determine the TBS for each of the adjusted sub-channels. In some examples, the terminal device 310 may use a reference number (such as the configured sub-channel size described above) and adapt a modulation and coding scheme (MCS) to fit data into each of the adjusted sub-channels.

In some examples, the number of remaining PRBs is not smaller than or greater than the threshold, and the remaining PRBs may be used as an independent sub-channel. In some examples, the terminal device 310 may determine the TBS by: using a predefined sub-channel size of each of the multiple sub-channels (i.e., the configured sub-channel size) as a reference number; and adapting the MCS to fit data into the number of remaining PRBs. For example, the configured sub-channel size (n_{subCHsize}) may be used as a reference number of PRBs for TBS determination, and the MCS may be adapted to fit the data into a smaller number of PRBs, i.e., the number of remaining PRBs smaller than the configured sub-channel size (n_{subCHsize}).

In some examples, the number of remaining PRBs is smaller than or not greater than the threshold, and the number of remaining PRBs may be combined into a sub-channel, e.g., a sub-channel nearest to the remaining PRBs. In some examples, the terminal device 310 may determine the TBS by: using a predefined sub-channel size of each of the multiple sub-channels (i.e., the configured sub-channel size) as a reference number; and adapting the MCS to fit data into the extended sub-channel including the remaining PRBs. For example, the configured sub-channel size (n_{subCHsize}) may be used as a reference number of PRBs for TBS determination, and the MCS may be adapted to fit the data into a larger number of PRBs, i.e., the configured sub-channel size (n_{subCHsize}) plus the number of remaining PRBs.

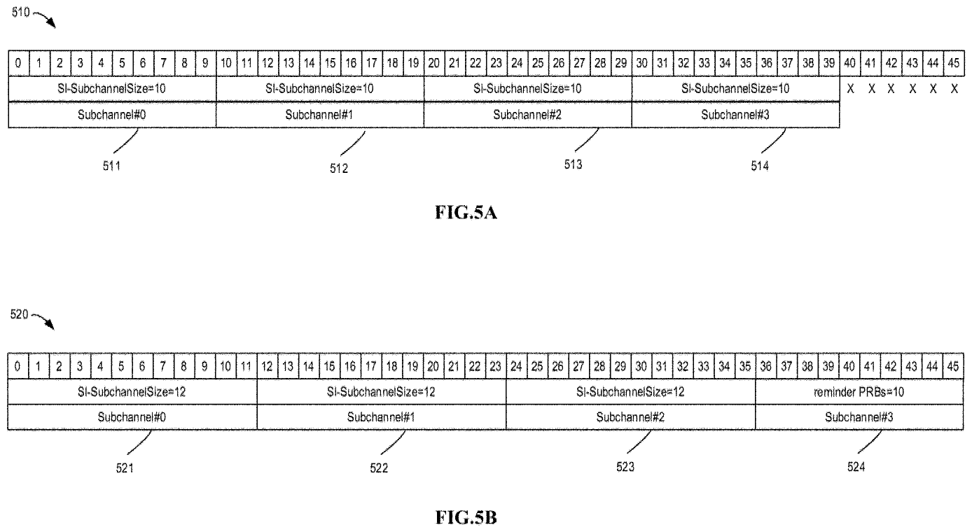

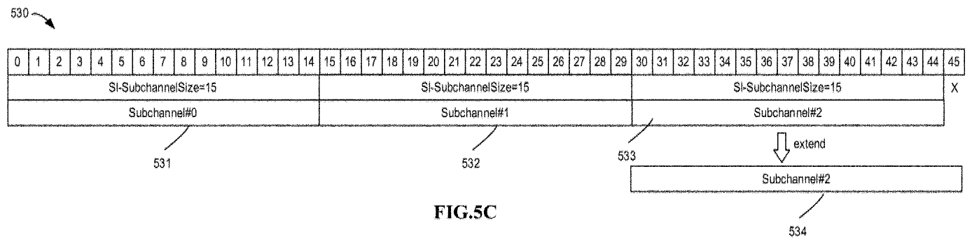

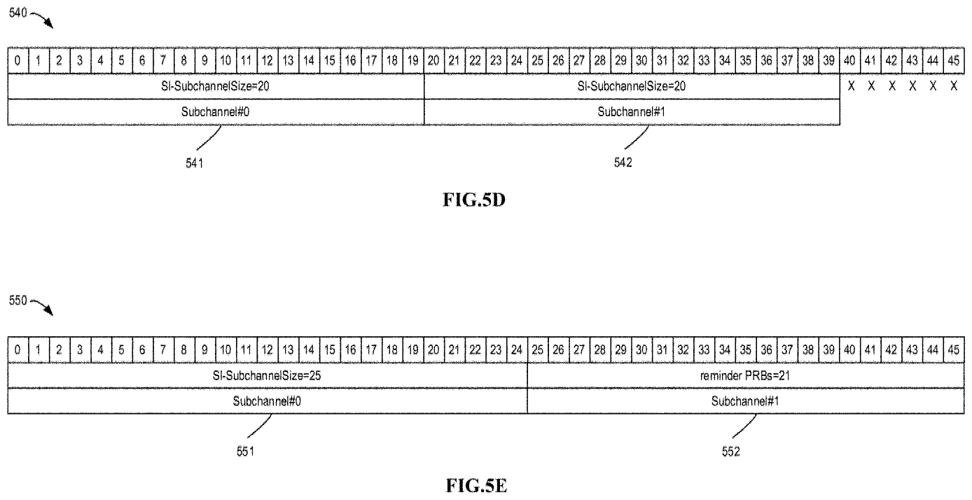

FIGS. 5A-5E illustrate some examples of mapping between sub-channels and PRBs with different numbers of PRBs of the resource pool or different sub-channel sizes in accordance with some embodiments of the present disclosure. In the examples shown in FIGS. 5A-5E, it is assumed that the threshold is 9, or is 0.7×the sub-channel size, where the ratio is 0.7.

FIG. 5A illustrates an example 510 with a resource pool with NPRB=46 RBs, a sub-channel size 10, i.e., sl-SubchannelSize=10, and the starting RB is 0, i.e., sl-StartRB-Subchannel=0. In the example 510, the threshold is 9 or 7 (sl-SubchannelSize × the ratio). As shown in FIG. 5A, the number of PRBs of the resource pool cannot be divided by sub-channel size, there are 4 sub-channels 511-514, and there are 6 remaining PRBs. Since the number of remaining PRBs (i.e., 6) is smaller than the threshold, the 6 remaining PRBs are unused in the example 510.

FIG. 5B illustrates an example 520 with a resource pool with NPRB=46 RBs, a sub-channel size 12, i.e., sl-SubchannelSize=12, and the starting RB is 0, i.e., sl-StartRB-Subchannel=0. In the example 520, the threshold is 9 or 8.4 (sl-SubchannelSize × the ratio). As shown in FIG. 5B, the number of PRBs of the resource pool cannot be divided by sub-channel size, there are 3 sub-channels 521-523, and there are 10 remaining PRBs. Since the number of remaining PRBs (i.e., 10) is larger than the threshold, the 10 remaining PRBs are used as a further sub-channel 524 with a size 10.

FIG. 5C illustrates an example 530 with a resource pool with NPRB=46 RBs, a sub-channel size 15, i.e., sl-SubchannelSize=15, and the starting RB is 0, i.e., sl-StartRB-Subchannel=0. In the example 530, the threshold is 9 or 10.5 (sl-SubchannelSize × the ratio). As shown in FIG. 5C, the number of PRBs of the resource pool cannot be divided by sub-channel size, there are 3 sub-channels 531-533, and there is 1 remaining PRB. Since the number of remaining PRBs (i.e., 1) is smaller than the threshold, the 1 remaining PRB is combined into the sub-channel 533, as shown in FIG. 5C, a sub-channel 534 with 16 PRBs may be determined.

FIG. 5D illustrates an example 540 with a resource pool with NPRB=46 RBs, a sub-channel size 20, i.e., sl-SubchannelSize=20, and the starting RB is 0, i.e., sl-StartRB-Subchannel=0. In the example 540, the threshold is 9 or 14 (sl-SubchannelSize × the ratio). As shown in FIG. 5D, the number of PRBs of the resource pool cannot be divided by sub-channel size, there are 2 sub-channels 541-542, and there are 6 remaining PRBs. Since the number of remaining PRBs (i.e., 6) is smaller than the threshold, the 6 remaining PRBs are unused in the example 540.

FIG. 5E illustrates an example 550 with a resource pool with NPRB=46 RBs, a sub-channel size 25, i.e., sl-SubchannelSize=25, and the starting RB is 0, i.e., sl-StartRB-Subchannel=0. In the example 550, the threshold is 9 or 17.5 (sl-SubchannelSize × the ratio). As shown in FIG. 5E, the number of PRBs of the resource pool cannot be divided by sub-channel size, there is one sub-channel 551, and there are 21 remaining PRBs. Since the number of remaining PRBs (i.e., 21) is larger than the threshold, the 21 remaining PRBs are used as a further sub-channel 552 with a size 21.

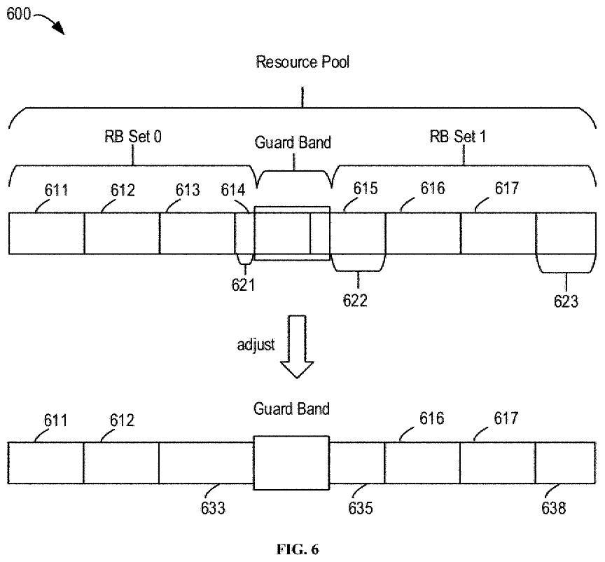

FIG. 6 illustrates an example of mapping 600 between sub-channels and PRBs in accordance with some embodiments of the present disclosure. As shown in FIG. 6, the resource pool may include an RB set 0, an RB set 1, and a guard band therebetween. It is assumed an initiating mapping is performed based on the option with reference to FIG. 1A, and seven sub-channels 611-617 and some rest PRBs 623 without mapping may be determined, where each of sub-channels 611-617 has a configured sub-channel size.

As shown in FIG. 6, there are three sets of remaining PRBs 621, 622, and 623. Specifically, since some PRBs of sub-channel 614 are punctured by the guard band, the one or more PRBs not overlapped with the guard band may be regarded as a set of remaining PRBs 621; since some PRBs of sub-channel 615 are punctured by the guard band, the one or more PRBs not overlapped with the guard band may be regarded as a set of remaining PRBs 622; since some rest PRBs 623 are not mapped with any sub-channel, the rest PRBs 623 may be regarded as a set of remaining PRBs 623.

It is assumed that a threshold equals to half of the configured sub-channel size. Since the set of remaining PRBs 621 has less PRBs than the threshold, the nearest sub-channel (i.e., the sub-channel 613) is extended by the set of remaining PRBs 621, for example, to be a sub-channel 633. Since the set of remaining PRBs 622 has more PRBs than the threshold, they can be mapped to an independent sub-channel, i.e., the sub-channel 635. Since the set of remaining PRBs 623 has more PRBs than the threshold, they can be mapped to an independent sub-channel, i.e., the sub-channel 638.

Additionally, the configured sub-channel size can be used as a reference number for TBS determination, and practically by adapting the MCS to fit data into each of these sub-channels 633, 635, and 638.

It is to be understood that the embodiments with reference to FIGS. 4-6 are only for purpose of description without any limitation of the present disclosure. In some examples, a proportion threshold may be predefined or pre-configured. If a ratio of the number of remaining PRBs to the configured sub-channel size is smaller than or not greater than the proportion threshold, the number of remaining PRBs may be combined into the nearest sub-channel or may be leaved unused. If a ratio of the number of remaining PRBs to the configured sub-channel size is not smaller than or greater than the proportion threshold, the number of remaining PRBs may be mapped with a further sub-channel.

According to the embodiments with reference to FIGS. 4-6, the terminal device 310 may adjust the mapping of sub-channels with PRBs in a resource pool, for example, a nearest sub-channel may be expanded or a new sub-channel may be mapped. Thus, the remaining PRBs may be used for scheduling and resource allocation accordingly. Therefore, the spectrum efficiency may be improved.

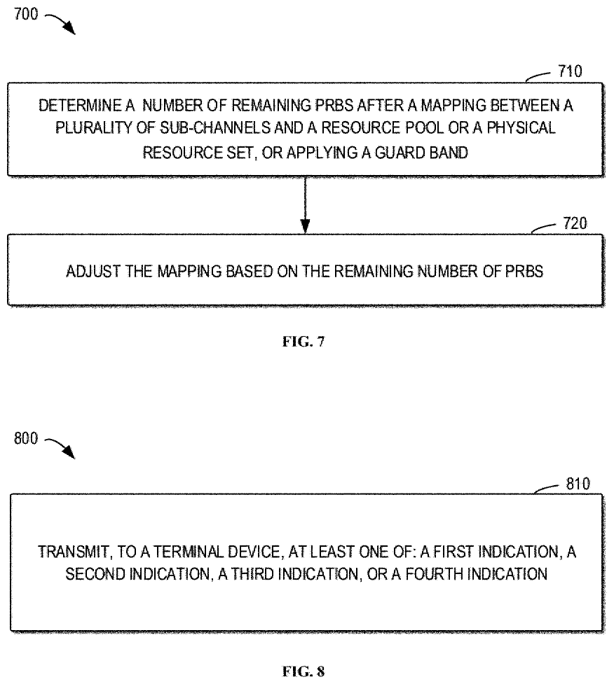

FIG. 7 illustrates a flowchart of a method 700 implemented at a terminal device in accordance with some example embodiments of the present disclosure. For the purpose of discussion, the method 700 will be described from the perspective of the terminal device 310 with reference to FIG. 3.

At block 710, the terminal device 310 determines a number of remaining physical resource blocks (PRBs) after a mapping between a plurality of sub-channels and a resource pool or a physical resource set, or applying a guard band. At block 720, the terminal device 310 adjusts the mapping based on the number of remaining PRBs.

In some example embodiments, if one or more PRBs are not mapped, the terminal device 310 determines that the remaining PRBs include the one or more PRBs. In some example embodiments, if a sub-channel of the plurality of sub-channels is overlapped with the guard band, the terminal device 310 determines that the remaining PRBs include at least one PRB of the sub-channel overlapping with the guard band, where the at least one PRB is not within the guard band.

In some example embodiments, if the number of remaining PRBs and a threshold meet a first condition, the terminal device 310 extends a sub-channel of the plurality of sub-channels, such as for example, the sub-channel nearest to the remaining PRBs, by the number of remaining PRBs. In some other example embodiments, if the number of remaining PRBs and a threshold meet a first condition, the terminal device 310 leaves the remaining PRBs unused.

In some example embodiments, if the number of remaining PRBs and the threshold meet a second condition, the terminal device 310 maps a sub-channel with the remaining PRBs.

In some example embodiments, the first condition is the number of remaining PRBs is smaller than or not greater than the threshold, and the second condition is the number of remaining PRBs is not smaller than or greater than the threshold.

In some example embodiments, the terminal device 310 receives, from a network device, an indication comprising the threshold or a ratio, the ratio is used for determining the threshold.

In some example embodiments, the terminal device 310 determines the threshold by multiplying a predefined sub-channel size by a ratio.

In some example embodiments, the terminal device 310 receives, from a network device, at least one of: a first indication indicating to leave the remaining PRBs unused, a second indication indicating to extend a sub-channel of the plurality of sub-channels nearest to the remaining PRBs by the number of remaining PRBs, a third indication indicating to map a sub-channel with the remaining PRBs, or a fourth indication indicating the terminal device to adjust the mapping according to the terminal device's implementation.

In some example embodiments, the terminal device 310 determines a TBS by: using a predefined sub-channel size as a reference number; and adapting a modulation and coding scheme (MCS) to fit data into a sub-channel comprising the remaining PRBs.

FIG. 8 illustrates a flowchart of a method 800 implemented at a network device in accordance with some example embodiments of the present disclosure. For the purpose of discussion, the method 800 will be described from the perspective of the network device 320 with reference to FIG. 3.

At block 810, the network device 320 transmits, to a terminal device, at least one of: a first indication indicating to leave remaining physical resource blocks (PRBs) unused, a second indication indicating to extend a sub-channel of a plurality of sub-channels nearest to the remaining PRBs by the number of remaining PRBs, a third indication indicating to map a sub-channel with the remaining PRBs, or a fourth indication indicating the terminal device to adjust the mapping according to the terminal device's implementation, a number of the remaining PRBs being determined by the terminal device after a mapping between the plurality of sub-channels and a resource pool or a physical resource set, or applying a guard band.

In some example embodiments, the network device 320 transmits, to the terminal device, an indication comprising a threshold or a ratio, the ratio is used for determining the threshold, and the threshold is used for comparing with the number of remaining PRBs.

In some example embodiments, an apparatus capable of performing the method 700 (for example, the terminal device 310) may comprise means for performing the respective steps of the method 700. The means may be implemented in any suitable form. For example, the means may be implemented in a circuitry or software module.

In some example embodiments, the apparatus comprises: means for determining a number of remaining physical resource blocks (PRBs) after a mapping between a plurality of sub-channels and a resource pool or a physical resource set; and means for adjusting the mapping based on the number of remaining PRBs.

In some example embodiments, means for determining a number of remaining PRBs comprises: means for in accordance with a determination that one or more PRBs are not mapped, determining that the remaining PRBs comprise the one or more PRBs; or means for in accordance with a determination that a sub-channel of the plurality of sub-channels is overlapped with a guard band, determining that the remaining PRBs comprise at least one PRB of the sub-channel overlapping with the guard band, where the at least one PRB is not within the guard band.

In some example embodiments, means for adjusting the mapping comprises: means for in accordance with a determination that the number of remaining PRBs and a threshold meet a first condition, extending a sub-channel of the plurality of sub-channels, such as for example, the sub-channel nearest to the remaining PRBs, by the number of remaining PRBs; or means for in accordance with a determination that the number of remaining PRBs and the threshold meet a second condition, mapping a sub-channel with the remaining PRBs.

In some example embodiments, means for adjusting the mapping comprises: means for in accordance with a determination that the number of remaining PRBs and a threshold meet a first condition, leaving the remaining PRBs unused; or means for in accordance with a determination that the number of remaining PRBs and the threshold meet a second condition, mapping a sub-channel with the remaining PRBs.

In some example embodiments, the first condition is the number of remaining PRBs is smaller than or not greater than the threshold, and the second condition is the number of remaining PRBs is not smaller than or greater than the threshold.

In some example embodiments, the apparatus further comprises: means for receiving, from a network device, an indication comprising the threshold or a ratio, the ratio is used for determining the threshold.

In some example embodiments, the apparatus further comprises: means for determining the threshold by multiplying a predefined sub-channel size by a ratio.

In some example embodiments, the apparatus further comprises: means for receiving, from a network device, at least one of: a first indication indicating to leave the remaining PRBs unused, a second indication indicating to extend a sub-channel of the plurality of sub-channels nearest to the remaining PRBs by the number of remaining PRBs, a third indication indicating to map a sub-channel with the remaining PRBs, or a fourth indication indicating the terminal device to adjust the mapping according to the terminal device's implementation.

In some example embodiments, the apparatus further comprises: means for determining a transport block size (TBS) with the number of remaining PRBs. In some example embodiments, means for determining the TBS comprises: means for using a predefined sub-channel size as a reference number; and means for adapting a modulation and coding scheme (MCS) to fit data into a sub-channel comprising the number of remaining PRBs.

In some example embodiments, an apparatus capable of performing the method 800 (for example, the network device 320) may comprise means for performing the respective steps of the method 800. The means may be implemented in any suitable form. For example, the means may be implemented in a circuitry or software module.

In some example embodiments, the apparatus comprises: means for transmitting, to a terminal device, at least one of: a first indication indicating to leave remaining physical resource blocks (PRBs) unused, a second indication indicating to extend a sub-channel of a plurality of sub-channels nearest to the remaining PRBs by the number of remaining PRBs, a third indication indicating to map a sub-channel with the remaining PRBs, or a fourth indication indicating the terminal device to adjust the mapping according to the terminal device's implementation, where a number of the remaining PRBs being determined by the terminal device after a mapping between the plurality of sub-channels and a resource pool or a physical resource set, or applying a guard band.

In some example embodiments, the apparatus further comprises: means for transmitting, to the terminal device, an indication comprising a threshold or a ratio, the ratio is used for determining the threshold, and the threshold is used for comparing with the number of the remaining PRBs.

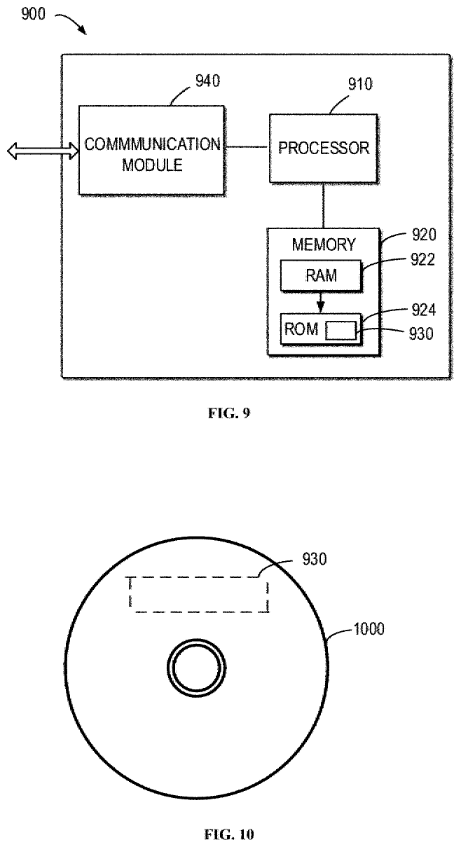

FIG. 9 illustrates a simplified block diagram of a device 900 that is suitable for implementing some example embodiments of the present disclosure. The device 900 may be provided to implement the communication device, for example the terminal device 310, or the network device 320 as shown in FIG. 3. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 4-8. The embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like.

FIG. 10 illustrates a block diagram of an example of a computer readable medium 1000 in accordance with some example embodiments of the present disclosure. The computer readable medium 1000 has the program 930 stored thereon. It is noted that although the computer readable medium 1000 is depicted in form of CD or DVD in FIG. 10, the computer readable medium 1000 may be in any other form suitable for carry or hold the program 930.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 7-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-16. (canceled)

17. A terminal device, comprising:
at least one processor; and
at least one memory storing instructions that, when executed by the at least one processor, cause the terminal device at least to:
determine a number of remaining physical resource blocks (PRBs) after a mapping between a plurality of sub-channels and a resource pool or a physical resource set, or applying a guard band; and
adjust the mapping based on the number of remaining PRBs.

18. The terminal device of claim 17, wherein the terminal device is caused to determine the number of remaining PRBs by at least one of:
in accordance with a determination that one or more PRBs are not mapped, determining that the remaining PRBs comprise the one or more PRBs; or
in accordance with a determination that a sub-channel of the plurality of sub-channels is overlapped with the guard band, determining that the remaining PRBs comprise at least one PRB of the sub-channel overlapping with the guard band, wherein the at least one PRB is not within the guard band.

19. The terminal device of claim 17, wherein the terminal device is caused to adjust the mapping by:
in accordance with a determination that the number of remaining PRBs and a threshold meet a first condition, extending a sub-channel of the plurality of sub-channels by the number of remaining PRBs; or
in accordance with a determination that the number of remaining PRBs and the threshold meet a second condition, mapping a sub-channel with the remaining PRBs.

20. The terminal device of claim 17, wherein the terminal device is caused to adjust the mapping by:
in accordance with a determination that the number of remaining PRBs and a threshold meet a first condition, leave the remaining PRBs unused, or
in accordance with a determination that the number of remaining PRBs and the threshold meet a second condition, mapping a sub-channel with the remaining PRBs.

21. The terminal device of claim 19, wherein,
the first condition is the number of remaining PRBs is smaller than or not greater than the threshold, and the second condition is the number of remaining PRBs is not smaller than or greater than the threshold.

22. The terminal device of claim 19, wherein the terminal device is further caused to:
receive, from a network device, an indication comprising the threshold or a ratio, the ratio is used for determining the threshold.

23. The terminal device of claim 19, wherein the terminal device is further caused to:
determine the threshold by multiplying a predefined sub-channel size by a ratio.

24. The terminal device of claim 17, wherein the terminal device is further caused to:
receive, from a network device, at least one of:
a first indication indicating to leave the remaining PRBs unused,
a second indication indicating to extend a sub-channel of the plurality of sub-channels nearest to the remaining PRBs by the number of remaining PRBs,
a third indication indicating to map a sub-channel with the remaining PRBs, or
a fourth indication indicating the terminal device to adjust the mapping according to the terminal device's implementation.

25. The terminal device of claim 17, wherein the terminal device is further caused to determine a transport block size (TBS) with the remaining PRBs by:
using a predefined sub-channel size as a reference number; and
adapting a modulation and coding scheme (MCS) to fit data into a sub-channel comprising the remaining PRBs.

26. A network device, comprising:
at least one processor; and
at least one memory storing instructions that, when executed by the at least one processor, cause the network device at least to:
transmit, to a terminal device, at least one of:
a first indication indicating to leave remaining physical resource blocks (PRBs) unused,
a second indication indicating to extend a sub-channel of a plurality of sub-channels nearest to the remaining PRBs by a number of the remaining PRBs,
a third indication indicating to map a sub-channel with the remaining PRBs, or
a fourth indication indicating the terminal device to adjust the mapping according to the terminal device's implementation,
the number of the remaining PRBs being determined by the terminal device after a mapping between the plurality of sub-channels and a resource pool or a physical resource set, or applying a guard band.

27. The network device of claim 26, wherein the network device is further caused to:
transmit, to the terminal device, an indication comprising a threshold or a ratio, the ratio is used for determining the threshold, and the threshold is used for comparing with the number of remaining PRBs.

28. A method, comprising:
determining, at a terminal device, a number of remaining physical resource blocks (PRBs) after a mapping between a plurality of sub-channels and a resource pool or a physical resource set, or applying a guard band; and
adjusting the mapping based on the number of remaining PRBs.
